(19) United States
(12) Patent Application Publication
(10) Pub. No.: US 2018/0288093 A1
(43) Pub. Date: Oct. 4, 2018

(54) SENSOR MANAGEMENT SYSTEM, SENSOR MANAGEMENT METHOD, RECORDING MEDIUM STORING SENSOR MANAGEMENT PROGRAM, AND SENSOR MANAGEMENT DEVICE

(71) Applicant: Oki Electric Industry Co., Ltd., Tokyo (JP)

(72) Inventor: Kei KATO, Tokyo (JP)

(73) Assignee: Oki Electric Industry Co., Ltd., Tokyo (JP)

(21) Appl. No.: 15/883,258

(22) Filed: Jan. 30, 2018

(30) Foreign Application Priority Data
Mar. 31, 2017 (JP) 2017-070154

(51) Int. Cl. H04L 29/06

(52) U.S. Cl. CPC H04L 63/18; H04W 4/38; H04L 63/166; H04L 63/0227

(57) ABSTRACT

A sensor management system includes: a sensor management device including predetermined security functionality, wherein the sensor management device receives data in a case in which the data has been transmitted from the sensor device by a first communication method and transmits the received data to a predetermined network; a communication device that relays the data to the network in a case in which the data has been transmitted from the sensor device by a second communication method; and a server device that receives the data from the sensor management device or from the communication device via the network. The sensor management device includes a communication method determination unit that determines, based on a security configuration included in the sensor device, a communication method for use by the sensor device, in a case of transmitting the data, to be either the first communication method or the second communication method.

### CROSS-REFERENCE TO RELATED APPLICATION

This application is based upon and claims the benefit of priority of the prior Japanese Patent Application No. 2017-070154, filed on Mar. 31, 2017, the entire contents of which is incorporated herein by reference.

### FIELD

The present disclosure relates to a sensor management system, a sensor management method, a recording medium recorded with a sensor management program, and a sensor management device, and may be applied in situations in which, for example, data collected by sensors is transmitted to a server via a network.

### BACKGROUND

Recently there have been proposals for what is referred to as the Internet of Things (IoT), in which various objects are connected over a network, in an arrangement such that various information obtained by these objects is exchanged in an interconnected manner, and, moreover, interconnected control is performed. Moreover, there are also proposals to accumulate the vast amounts of information obtained by the IoT on servers, or the like, so as to be handled in what is referred to as big data, for various purposes.

In the IoT, sometimes wireless communication functionality is installed in sensor devices for collecting data, and a gateway device is provided that includes wireless communication functionality compatible with that of the sensor devices, in order to facilitate installation by rendering wiring installation unnecessary. In such cases, the wireless communication employed is assumed to be, for example, a wireless local area network (LAN), BLUETOOTH (registered trademark), or the like, with communication distances being comparatively close distances of the order of several meters or several tens of meters.

The gateway device is also connected to a network such as the Internet, and is able transmit data that has been transmitted from sensor devices by wireless communication, via the network, to a predetermined server device. Such a gateway device is generally provided with various security functionality, such as encryption functionality and authorization functionality, or Denial of Service (DoS) detection functionality, so as to ensure the confidentiality, integrity, and availability of communication.

One proposal is a gateway device that identifies whether or not a sensor device (also referred to as a client device) is a legitimate pre-registered sensor device in response to a connection request transmitted from the sensor device (see, for example, Japanese Patent Application Laid-Open (JP-A) No. 2017-46338 (FIG. 2, etc.)).

However, what are referred to as low power wide area (LPWA) technologies are recently being proposed as wireless communication technologies suited for the IoT. In LPWA, communication distances are intermediate to long distances of, for example, several kilometers to several tens of kilometers, rendering relay by a gateway device unnecessary, and employing direct communication between sensor devices and base stations installed by communication providers and the like.

However, there is a concern that a sensor device that does not include sufficient security functionality could be subject to unauthorized external access over LPWA, resulting in various problems such as the leakage or alteration of data, or the establishment of a stepping stone for unauthorized access to other network devices.

### SUMMARY

The present disclosure provides a sensor management system capable of determining a communication method appropriate to a sensor device, while ensuring security, and to a sensor management method, a sensor management program, and a sensor management device of the same.

A sensor management system of the present disclosure includes: a sensor device that collects data and transmits the collected data by a first communication method or a second communication method; a sensor management device including predetermined security functionality, wherein the sensor management device receives the data in a case in which the data has been transmitted from the sensor device by the first communication method and transmits the received data to a predetermined network; a communication device that relays the data to the network in a case in which the data has been transmitted from the sensor device by the second communication method; and a server device that receives the data from the sensor management device or from the communication device via the network. The sensor management device includes a communication method determination unit that determines, based on a security configuration included in the sensor device, a communication method for use by the sensor device, in a case of transmitting the data, to be either the first communication method or the second communication method.

### BRIEF DESCRIPTION OF DRAWINGS

FIG. 1 is a schematic diagram illustrating overall configuration of a sensor management system.

FIG. 2 is a block diagram illustrating configuration of a server device.

FIG. 3 is a block diagram illustrating configuration of a gateway device.

FIG. 4 is a schematic chart depicting a communication method determination table of a first exemplary embodiment.

FIG. 5A and FIG. 5B are block diagrams illustrating configuration of a sensor device of the first exemplary embodiment.

FIG. 6A and FIG. 6B are schematic charts depicting security information tables of the first exemplary embodiment.

FIG. 7 is a sequence chart illustrating a communication method determination sequence.

FIG. 8 is a flowchart illustrating a communication method determination processing procedure of the first exemplary embodiment.

FIG. 9A and FIG. 9B are schematic diagrams illustrating communication routes for respective sensor devices.

FIG. 10 is a schematic diagram illustrating configuration of a communication route display screen.

FIG. 11 is a schematic chart depicting a communication method determination table of a second exemplary embodiment.

FIG. 12A and FIG. 12B are block diagrams illustrating configuration of sensor devices of the second exemplary embodiment.

FIG. 13A and FIG. 13B are schematic charts depicting security information tables of the second exemplary embodiment.

FIG. 14 is a flowchart illustrating a communication method determination processing procedure of the second exemplary embodiment.

FIG. 15 are schematic charts depicting a communication method determination table of a third exemplary embodiment.

FIG. 16A and FIG. 16B are block diagrams illustrating configuration of sensor devices of the third exemplary embodiment.

FIG. 17A and FIG. 17B are schematic charts depicting security information tables of the third exemplary embodiment.

FIG. 18 is a flowchart illustrating a communication method determination processing procedure of the third exemplary embodiment.

FIG. 19A and FIG. 19B are schematic charts depicting communication method determination tables of a fourth exemplary embodiment.

FIG. 20A and FIG. 20B are schematic charts depicting security information tables of the fourth exemplary embodiment.

FIG. 21 is a flowchart illustrating a communication method determination processing procedure of the fourth exemplary embodiment.

### DETAILED DESCRIPTION

Explanation follows regarding embodiments for implementing the invention (referred to hereinafter as exemplary embodiments), with reference to the drawings.

### 1. First Exemplary Embodiment

1-1. Sensor Management System Configuration

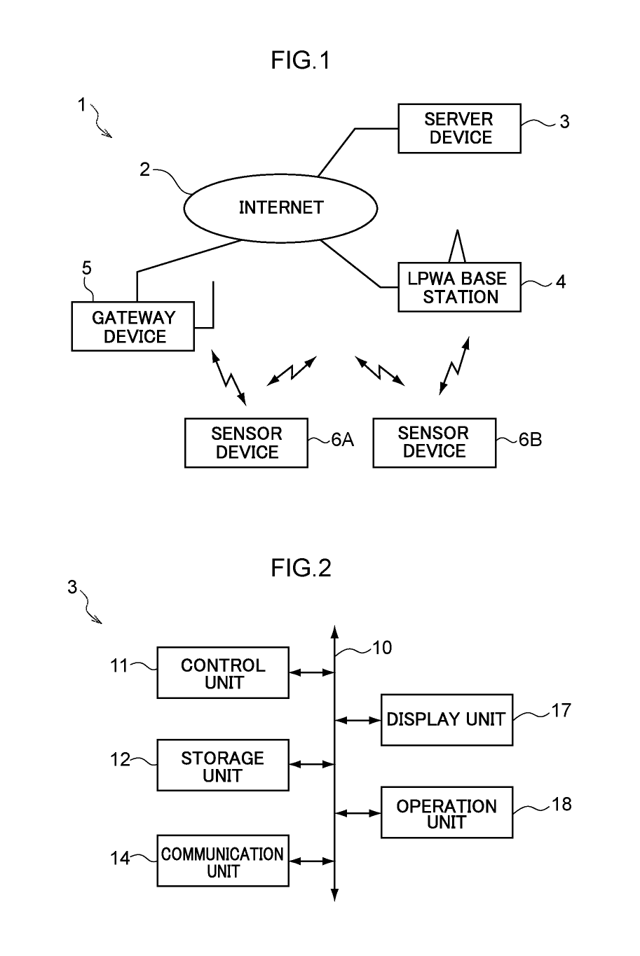

As illustrated in FIG. 1, in a sensor management system 1 according to a first exemplary embodiment, a server device 3, a LPWA base station 4, and a gateway (GW) device 5 are connected to each other through the Internet 2 such that information is able to be exchanged therebetween. Sensor devices 6A and 6B (also referred to collectively below as sensor devices 6) are also provided to the sensor management system 1.

1-1-1. Server Device and LPWA Base Station Configuration

As illustrated in the schematic block diagram of FIG. 2, in the server device 3, a control unit 11, a storage unit 12, a communication unit 14, a display unit 17, and an operation unit 18 are connected to each other through a bus 10 such that information is able to be passed therebetween over the bus 10.

The control unit 11 is configured around a central processing unit (CPU), reads a predetermined program from read only memory (ROM), flash memory, or the like, and uses random access memory (RAM) as a work area while executing various processing, such as data accumulation processing.

The storage unit 12 is a non-volatile information storage medium such as, for example, a hard disk drive or flash memory, and the storage unit 12 stores various programs and various setting information, or various data transmitted from the sensor devices 6, and the like. Information relating to a communication method for the sensor devices 6 is also stored in the storage unit 12.

The communication unit 14 is, for example, an interface of a wired local area network (LAN) based on a standard such as the Institute of Electrical and Electronics Engineers (IEEE) 802.3u/ab standard, and the communication unit 14 is connected to the Internet 2 (FIG. 1) by the wired LAN. When supplied with data from the control unit 11, for example, the communication unit 14 implements processing to packetize the data, then transmits the data over the Internet 2 after embedding information such as a destination address therein as appropriate. Upon receiving data in packet format from the Internet 2, for example, the communication unit 14 implements depacketization processing and the like on the data to recover the data, and then supplies the data to the control unit 11.

The display unit 17, serving as a presentation unit, is a display device such as a liquid crystal panel. The display unit 17 displays screen data supplied from the control unit 11 so as to present various types of information to a user of the server device 3. The operation unit 18 is, for example, a keyboard or a mouse. The operation unit 18 generates operation instructions in accordance with input operations from a user of the server device 3 and supplies the input operations to the control unit 11.

The LPWA base station 4 (FIG. 1) is connected to the Internet 2 by a wired LAN or the like, and includes an LPWA-compatible signal processing unit, antenna, and the like. The LPWA base station 4 converts data (packets, etc.) received from the Internet 2 via the wired LAN or the like into a wireless signal using the signal processing unit, and emits the wireless signal from the antenna as LPWA waves. Further, after receiving LPWA waves using the antenna and converting the received LPWA waves into a wired signal, the LPWA base station 4 converts this signal into data (packets or the like) using the signal processing unit, and transmits this data to the Internet 2 through the wired LAN or the like.

LPWA refers to standardized communication technologies mainly used in the IoT field. LPWA utilizes frequency bands such as the 868 MHz band, the 915 MHz band, or the 920 MHz band, has transmission distances of one kilometer to several tens of kilometers, and has maximum transmission speeds of one hundred kilobytes to several hundred kilobytes per second (kbps). More precisely, several communication technologies, such as SIGFOX (registered trademark) and LoRaWAN, have been proposed by businesses and other industry organizations. For ease of explanation, hereinafter LPWA will be referred to as a second communication method.

1-1-2. Gateway Device Configuration

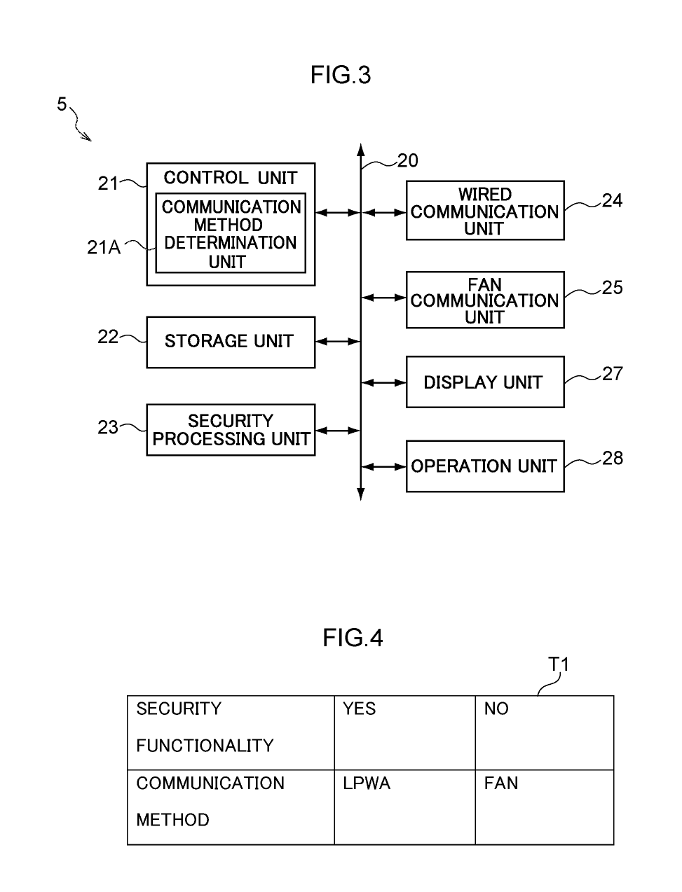

As illustrated in the schematic block diagram of FIG. 3, in the gateway device 5 (FIG. 1), which serves as a sensor management device, a control unit 21, a storage unit 22, a security processing unit 23, a wired communication unit 24, a Field Area Network (FAN) communication unit 25, a display unit 27, and an operation unit 28 are connected to each other through a bus 20 such that information is able to be passed therebetween over the bus 20.

Similarly to the control unit 11 (FIG. 2) of the server device 3, the control unit 21 is configured around a CPU, reads predetermined programs from ROM, flash memory, or the like, and uses RAM as a work area while executing various processing, such as data relay processing. The control unit 21 reads a communication method determination program from the flash memory, a storage unit 22, or the like, and is able to form a communication method determination unit 21A as a functional block by executing the communication method determination program.

The storage unit 22 is, for example, a non-volatile information storage medium such as, for example, flash memory, and the storage unit 22 stores various programs and various setting information. Moreover, a security condition, which is a condition to determine the communication method according to the security functionality of each of the sensor devices 6, is stored in the storage unit 22 as a communication method setting table T1, as illustrated in FIG. 4.

The communication method setting table T1 is prepared with headings for “security functionality” and “communication method”, is stored with “YES” or “NO” as values for the “security functionality”, and is stored with “LPWA” or “FAN” as respective values for the “communication method” associated therewith. Namely, in the communication method setting table T1, “security functionality included” is stipulated as a security condition in determining LPWA as the communication method.

Similarly to the communication unit 14 of the server device 3, the wired communication unit 24 serving as a network-side communication unit is, for example, an interface of a wired LAN based on a standard such as the IEEE 802.3u/ab standard, and the communication unit 24 is connected to the Internet 2 (FIG. 1) by the wired LAN. Also similarly to the communication unit 14, the wired communication unit 24 implements processing on data to packetize the data or the like, then transmits the data over the Internet 2, or implements depacketization processing or the like on packet format data received from the Internet 2 to recover the data.

The FAN communication unit 25 serving as a sensor-side communication unit is an interface for a wireless LAN based on a standard such as IEEE 802.11a/b/g/n/ac, BLUETOOTH (registered trademark), or the like, or a wireless communication standard for comparatively close communication distances, such as, for example, Wireless-Smart Utility Network (Wi-SUN), based on a standard such as IEEE 802.15.4g. The FAN communication unit 25 includes an antenna, a signal processing circuit, and the like. For ease of explanation, hereinafter FAN will be referred to as a first communication method.

When supplied with data from the control unit 21 or the like, the FAN communication unit 25 implements predetermined processing on the data such as packetization, followed by converting the data into a wireless signal, and emits the wireless signal from the antenna as FAN waves. Moreover, the FAN communication unit 25 receives FAN waves from the sensor devices 6 (FIG. 1) or the like using the antenna and converts the received FAN waves into a wired signal, implements depacketization processing to extract data therefrom, and supplies the extracted data to the control unit 21.

The display unit 27 is, for example, an indicator or the like employing a liquid crystal panel or a light emitting diode (LED), and, under control of the control unit 21, displays information such as predetermined text, images, and the like on the liquid crystal panel, or causes the LED to illuminate or be extinguished. The operation unit 28 is configured, for example, by plural operation buttons, and receives operational input by a user and notifies the control unit 21 thereof.

Thus configured, after, for example, receiving electromagnetic waves from the sensor devices 6 using the antenna of the FAN communication unit 25, the gateway device 5 converts these waves into data (packets or the like) using the signal processing unit, and transmits this data from the wired communication unit 24 to the Internet 2. Moreover, under control of the control unit 21, the gateway device 5 is able to transmit and receive various information to and from the sensor devices 6 by wireless communication employing the FAN communication unit 25.

The security processing unit 23 is configured, for example, so as to be able to execute various processing related to security, such as encryption processing, authentication processing, and Denial of Service (DoS) detection processing. The gateway device 5 is thereby able to perform various processing related to security using the security processing unit 23, such as for example encrypting information to transmit to the sensor devices 6, and performing authentication processing with an authentication server, or detecting and taking countermeasures against a DoS attack over the Internet 2.

1-1-3. Sensor Device Configuration

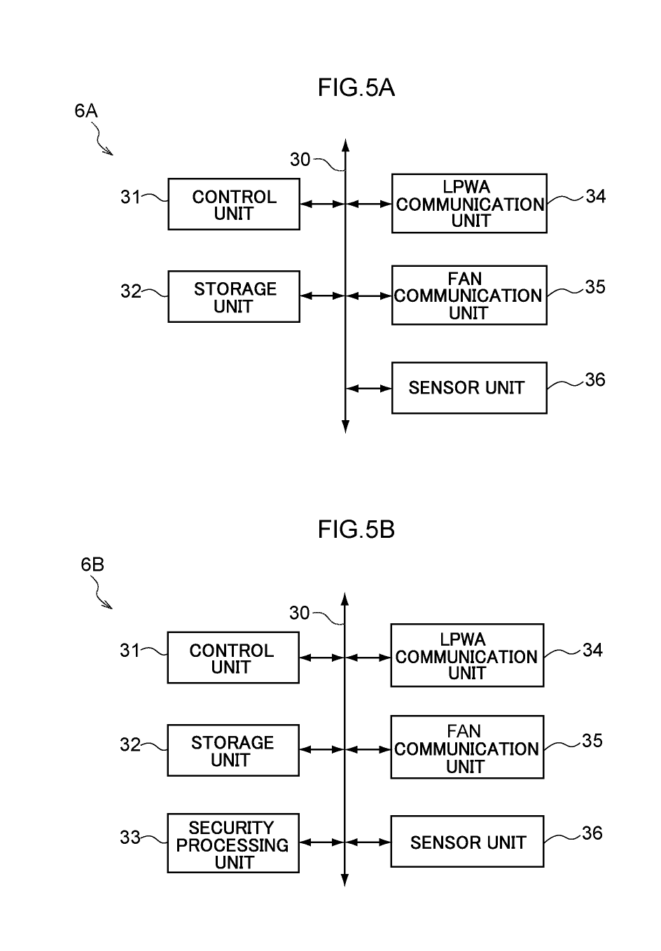

As illustrated in the schematic block diagram of FIG. 5A, a sensor device 6A (FIG. 1) includes a control unit 31, a storage unit 32, a LPWA communication unit 34, a FAN communication unit 35, and a sensor unit 36, connected to each other through a bus 30 such that information is able to be passed therebetween over the bus 30.

Similarly to the control unit 11 (FIG. 2) of the server device 3 and the control unit 21 (FIG. 3) of the gateway device 5, the control unit 31 is configured around a CPU, reads predetermined programs from ROM, flash memory, or the like, and uses RAM as a work area while executing various processing, such as data collection processing.

Similarly to the storage unit 22 of the gateway device 5, the storage unit 32, for example, is a non-volatile information storage medium such as, for example, flash memory, and the storage unit 32 stores various programs and various setting information. Various information related to the sensor devices 6 themselves is stored as device information in the storage unit 32. The device information includes, for example, a manufacturer name, model name, and the like of each of the sensor devices 6, a serial number or the like, a uniquely assigned device identifier (ID), network addresses, and furthermore, information indicating the type of data collected in the sensor unit 36, described later.

The LPWA communication unit 34 is an LPWA communication interface compatible with the LPWA base station 4 (FIG. 1), and includes an antenna and a signal processing circuit. When supplied with data from the control unit 31 or the like, the LPWA communication unit 34 implements predetermined processing on the data such as packetization, followed by converting the data into a wireless signal, and emits the wireless signal from the antenna as LPWA waves. These electromagnetic waves are able to be received by the LPWA base station 4. Further, after receiving LPWA waves transmitted from the LPWA base station 4 (FIG. 1) or the like and received using the antenna and converting the LPWA waves into a wired signal, the LPWA communication unit 34 implements depacketization processing to extract data therefrom, and supplies the extracted data to the control unit 31.

The FAN communication unit 35 is a FAN communication interface compatible with the gateway device 5 (FIG. 1 and FIG. 3), and includes an antenna and a signal processing circuit. When supplied with data from the control unit 31 or the like, the FAN communication unit 35 implements predetermined processing on the data such as packetization, followed by converting the data into a wireless signal, and emits the wireless signal from the antenna as FAN waves. Further, after receiving FAN waves transmitted from the gateway device 5 (FIG. 1) or the like using the antenna and converting the received FAN waves into a wired signal, the FAN communication unit 35 implements depacketization processing to extract data therefrom, and supplies the extracted data to the control unit 31.

The sensor unit 36 is, for example, a temperature/humidity sensor. The sensor unit 36 measures the temperature and humidity of the surroundings, generates data indicating the temperature and humidity (namely, collects data), and supplies this data to the control unit 31. For ease of explanation, hereinafter such data is also referred to as sensing data.

However, as illustrated in FIG. 5B, which corresponds to FIG. 5A, a sensor device 6B (FIG. 1) is provided with a security processing unit 33 in addition to the configuration of the sensor device 6A. Similarly to the security processing unit 23 (FIG. 3) of the gateway device 5, the security processing unit 33 is able to perform various processing related to security, such as for example encryption processing, authentication processing, and DoS detection processing.

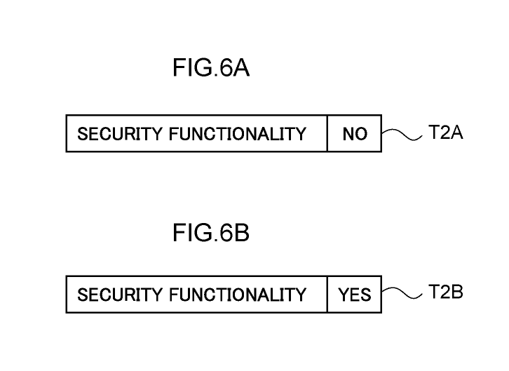

The storage unit 32 moreover also stores, as part of the above device information, security functionality information to indicate the presence or absence of security functionality by using a security information table T2 (T2A or T2B) as illustrated in FIG. 6A and FIG. 6B. The security information table T2A illustrated in FIG. 6A is stored in the storage unit 32 of the sensor device 6A (FIG. 5A). There is no security processing unit 33 such as described above provided to the sensor device 6A. As the security functionality information, “NO” is therefore stored in the security information table T2A, meaning that there is no security functionality present.

The security information table T2B illustrated in FIG. 6B is stored in the storage unit 32 of the sensor device 6B (FIG. 5B). The security processing unit 33 as described above is provided to the sensor device 6B. As the security functionality information, “YES” is therefore stored in the security information table T2B, meaning that security functionality is present.

In this manner, the sensor devices 6 are configured so as to be able to communicate information using two types of communication methods, LPWA and FAN. In addition, as part of device information stored in the storage unit 32, security functionality information to indicate the presence or absence of the security processing unit 33 in the sensor device 6 is stored in the security information table T2.

1-2. Communication Method Determination Processing

In the sensor management system 1, the sensor devices 6 are managed by the gateway device 5, and, configuration is made such that, as part of the management, the communication method is determined according to the presence or absence of security functionality in each of the sensor devices 6.

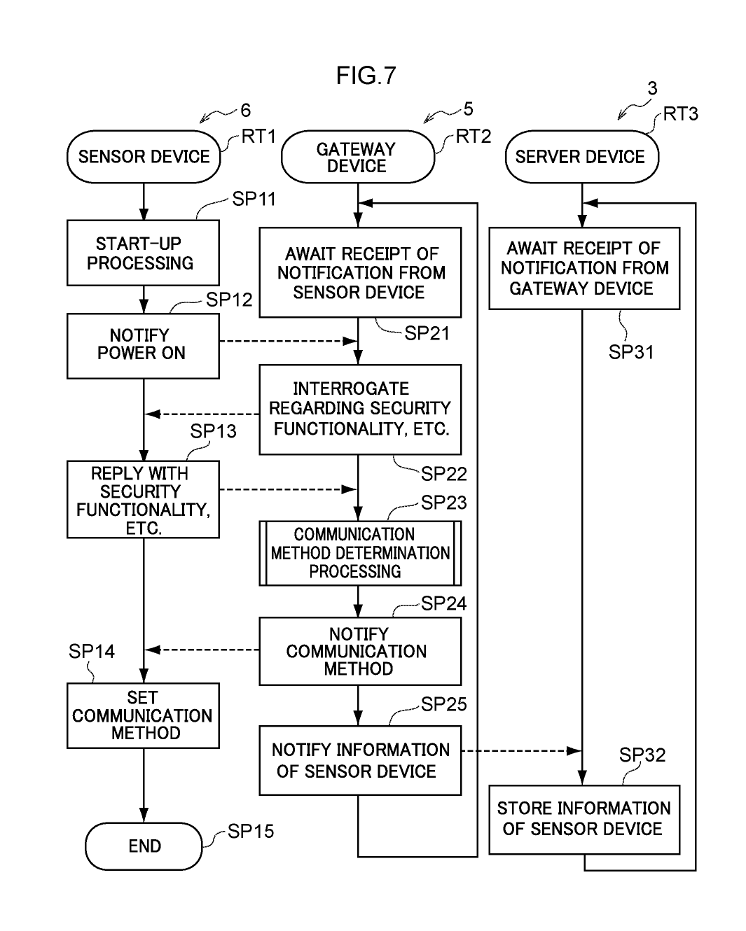

More precisely, in the sensor management system 1, in accordance with the sequence chart illustrated in FIG. 7, the communication method for each sensor device 6 is determined while information is exchanged between the sensor device 6, the gateway device 5, and the server device 3. Processing sequences RT2 and RT3 are started in the gateway device 5 and the server device 3 by switching ON power to the gateway device 5 and the server device 3 in advance, and executing respective predetermined programs therein.

When power is switched ON to the control unit 31 of the sensor devices 6, a processing sequence RT1 is started and processing transitions to step SP11. At step SP11, the control unit 31 executes predetermined start-up processing and the like, and then processing transitions to the next step SP12. At step SP12, the control unit 31 notifies the gateway device 5 with a power ON notification signal by FAN via the FAN communication unit 35 (FIG. 5A and FIG. 5B) to indicate that the power has been switched ON to the sensor devices 6.

In the sensor management system 1, the gateway device 5 exchanges various information with the plural sensor devices 6. When transmitting information by FAN to the gateway device 5, the sensor devices 6 append a device ID or the like to the information such that each of the sensor devices 6 is identifiable by the gateway device 5.

At step SP21 of the processing sequence RT2, the control unit 21 of the gateway device 5 waits to receive the power ON notification signals from the sensor devices 6, and processing transitions to step SP22 when the power ON notification signal is received from one of the sensor devices 6 by the FAN communication unit 25 (FIG. 3). At step SP22, the control unit 21 interrogates the sensor device 6 by FAN via the FAN communication unit 25 regarding security functionality and the like, then processing transitions to step SP23.

On receipt of an enquiry from the gateway device 5 regarding security functionality using the FAN communication unit 35, the control unit 31 of the sensor device 6 transitions to the next step SP13, and transmits a reply regarding security functionality to the gateway device 5. More precisely, the control unit 31 reads security functionality information from the security information table T2 (FIG. 6A and FIG. 6B) in the storage unit 32, and notifies the gateway device 5 by FAN via the FAN communication unit 35 (FIG. 5A and FIG. 5B). The gateway device 5 is thereby able to obtain knowledge about the security functionality of the sensor devices 6.

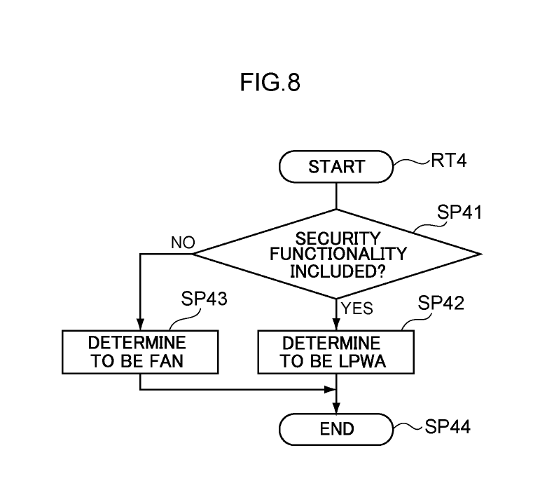

On receipt of security functionality information from one of the sensor devices 6 using the FAN communication unit 25 (FIG. 3), the control unit 21 of the gateway device 5 executes a subroutine at step SP23, and determines the communication method. More precisely, the control unit 21 starts the communication method determination processing sequence RT4 illustrated in FIG. 8, and then processing transitions to step SP41, where whether or not security functionality is present in the sensor device 6, or more precisely whether or not the security functionality is “YES”, is determined by the communication method determination unit 21A (FIG. 3).

When an affirmative result is obtained, this means that the sensor device 6 is a sensor device 6B (FIG. 5B) including a security processing unit 33. Namely, suppose information were to be exchanged by LPWA between the sensor device 6B and the LPWA base station 4, leakage or alteration of information would be effectively prevented by encryption processing, authentication processing, or the like, and appropriate countermeasures would be obtained to an external attack or the like over the Internet 2. In the communication method determination unit 21A of the control unit 21, processing then transitions to the next step SP42, and after determining the communication method the sensor device 6 (6B) should employ to be LPWA, processing transitions to the next step SP44.

However, when a negative result is obtained at step SP41, this means that the sensor device 6 is a sensor device 6A (FIG. 5A) lacking a security processing unit 33. Namely, suppose information were to be exchanged by LPWA between the sensor device 6A and the LPWA base station 4, then there would be a concern that leakage or alteration of the information might occur, and moreover that it would not be possible to take sufficient countermeasures to an external attack or the like over the Internet 2. However, if the sensor device 6A connects to the Internet 2 through the gateway device 5, then the security processing unit 23 (FIG. 3) of the gateway device 5 can be utilized, thereby enabling the security of information to be ensured. When this is the case in the communication method determination unit 21A of the control unit 21, processing transitions to the next step SP43, and after determining the communication method the sensor device 6 (6A) should employ to be FAN, processing transitions to step SP44.

At step SP44, in the communication method determination unit 21A of the control unit 21, the communication method determination processing sequence RT4 subroutine ends, and then processing transitions to the next step SP24 of the original processing sequence RT2 (FIG. 7). At step SP24, the control unit 21 notifies the sensor device 6 by FAN via the FAN communication unit 25 of the communication method that should be set, and then processing transitions to then next step SP25.

On receipt of the notification of the communication method that should be set from the gateway device 5 using the FAN communication unit 35, in the control unit 31 of the sensor device 6, processing transitions to the next step SP14, then after the notified communication method (FAN or LPWA) has been set, processing transitions to the next step SP15, and the processing sequence RT1 ends.

At step SP25, the control unit 21 of the gateway device 5 uses the wired communication unit 24 (FIG. 3) to notify the server device 3 of information related to the sensor device 6, for example, device ID, determined communication method, and the like, over the Internet 2. Processing then returns again to step SP21, and the control unit 21 awaits receipt of a notification from the next sensor device 6.

At step SP31 of the processing sequence RT3, the control unit 11 of the server device 3 awaits receipt of notification of information related to the sensor device 6 from the gateway device 5. When the control unit 11 receives notification from the gateway device 5 using the communication unit 14 (FIG. 2), processing transitions to step SP32. At step SP32, after the control unit 11 has stored, in the storage unit 12 (FIG. 2), information related to the sensor device 6 based on the notification received from the gateway device 5, processing returns again to step SP31, and the control unit 11 awaits receipt of the next notification.

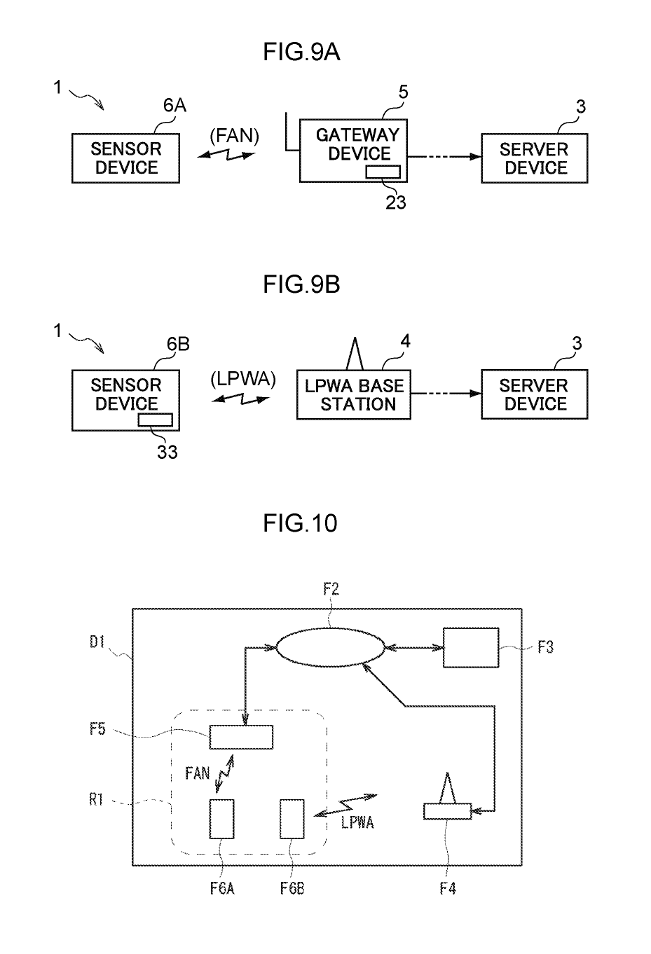

Thus, in the sensor management system 1, the communication method is set according to the security functionality of the sensor devices 6. For example, the communication method is set to FAN for sensor devices 6A (FIG. 5A) not possessing security functionality, and, as illustrated in the schematic diagram of FIG. 9A, the collected sensing data is transmitted by FAN to the gateway device 5. In response thereto, the gateway device 5 transmits the received sensing data to the server device 3 over the Internet 2 while appropriately employing the security processing unit 23 (FIG. 3), so as to accumulate the sensing data.

Moreover, for example, the communication method is set to LPWA for sensor devices 6B (FIG. 5B) possessing security functionality, and, as illustrated in the schematic diagram of FIG. 9B, the collected sensing data is transmitted by LPWA to the LPWA base station 4 while appropriately employing the security processing unit 33. In response thereto, the LPWA base station 4 transmits the received sensing data to the server device 3 via the Internet 2 without performing any particular processing related to security, so as to accumulate the sensing data.

The server device 3 (FIG. 2) is configured so as to be able to present, to the user, the communication route from each of the sensor devices 6 to the server device 3 in the sensor management system 1. More precisely, in response to operational instructions and the like from a user through the operation unit 18, the control unit 11 of the server device 3 displays a communication route display screen D1 such as illustrated in FIG. 10 on the display unit 17 based on information related to the sensor devices 6 stored in the storage unit 12 and the like.

In the communication route display screen D1, the Internet 2, the server device 3, the LPWA base station 4, the gateway device 5, and the sensor devices 6A and 6B are represented by predetermined graphic symbols F2, F3, F4, F5, and F6A and F6B, respectively. Moreover, in the communication route display screen D1, each of the graphic symbols F2, etc. are connected together by bent lines or the like according to the communication routes that are actually formed. Namely, each of the communication routes in the sensor management system 1 is displayed on the communication route display screen D1 as an image.

Therein, a wireless connection between the graphic symbols F6A and F5 is indicated by a bent double-arrow-headed line, together with the text “FAN” in the vicinity thereof, thereby representing that the communicative connection between the sensor device 6A and the gateway device 5 is by FAN. Moreover, a wireless connection between the graphic symbols F6B and F4 is indicated by a bent double-arrow-headed line, together with the text “LPWA” in the vicinity thereof, thereby representing that the communicative connection between the sensor device 6B and the LPWA base station 4 is by LPWA.

Moreover, in the communication route display screen D1, the periphery of the graphic symbols F5 and the graphic symbols F6A and F6B are surrounded by a broken line frame R1, thereby representing that the sensor devices 6A and 6B are both managed by the gateway device 5, and that their respective communication methods are determined by the gateway device 5.

1-3 Results

In the configuration described above, in the sensor management system 1 of the first exemplary embodiment, the presence of security functionality in the sensor devices 6 is used as a security condition, and the communication method is determined by the communication method determination unit 21A provided in the control unit 21 of the gateway device 5 according to whether or not the security condition is satisfied.

Namely, in the sensor management system 1, the communication method is set to LPWA when the sensor device 6 is a sensor device 6B (FIG. 5B) possessing security functionality, and sensing data is transmitted by LPWA communication between the sensor device 6B and the LPWA base station 4 without passing through the gateway device 5 (FIG. 9B). In such cases, since the sensor device 6B includes the security processing unit 33, theft or alteration of the sensing data can be prevented by encryption processing, authentication processing, and the like, and moreover, countermeasures can be taken against external attacks and the like over the Internet 2 by using DoS detection processing and the like.

In other words, in the sensor management system 1, the security of the sensing data and security of the sensor device 6B itself can be ensured by performing LPWA communication while utilizing the security processing unit 33 of the sensor device 6B, enabling the processing burden on the gateway device 5 to be reduced.

However, in the sensor management system 1, when the sensor device 6 is a sensor device 6A (FIG. 5A) lacking security functionality, the sensing data is transmitted by FAN communication between the sensor device 6A and the gateway device 5, with the sensing data being relayed through the gateway device 5 (FIG. 9A) for transmission to the server device 3 over the Internet 2.

Namely, although the sensor device 6A includes the LPWA communication unit 34, the sensor device 6A does not use the LPWA communication unit 34 and instead performs communication processing by FAN using the FAN communication unit 35. In such cases, in place of the sensor device 6A lacking security functionality, the gateway device 5 is able to prevent the theft or alteration of the sensing data by using the functionality of the security processing unit 23 for encryption processing, authentication processing, and the like, and moreover, is able to take countermeasures against external attacks and the like over the Internet 2 by using DoS detection processing and the like.

In other words, in the sensor management system 1, the security of the sensing data and the sensor device 6A can be ensured by stopping LPWA communication by a sensor device 6A lacking security functionality and by instead using the gateway device 5, without adding security functionality to the sensor device 6A.

When viewed from another perspective, in the sensor management system 1, when a new sensor device 6 is installed, the appropriate communication method can be set according the presence or absence of security functionality in the sensor device 6 simply by switching the power to the sensor device 6 ON, enabling both security to be ensured and also a high level of processing burden reduction to be achieved in the gateway device 5.

Moreover, in the sensor management system 1, the communication routes between each of the units in the sensor management system 1 can be displayed as the communication route display screen D1 (FIG. 10) on the display unit 17 (FIG. 2) of the server device 3 in accordance with an operation by a user or the like. In particular, even though the communication method for each of the sensor devices 6 in the sensor management system 1 is determined automatically by the gateway device 5, the determined communication methods can be readily ascertained by letting the user view the communication route display screen D1.

According to the configuration described above, in the sensor management system 1 according to the first exemplary embodiment, the communication method is determined by the gateway device 5 according to the presence or absence of the security functionality in the sensor devices 6. Namely, the communication method is set to LPWA for sensor devices 6B including security functionality, enabling security to be ensured by the security processing unit 33 of the sensor device 6B, and enabling the processing burden on the gateway device 5 to be reduced. However, the communication method is set to FAN for sensor devices 6A lacking security functionality, enabling security to be ensured by the security processing unit 23 of the gateway device 5 while maintaining a simple configuration. Thus, in the sensor management system 1, sensing data can be safely transmitted from each of the sensor devices 6, and moreover, countermeasures can be taken against external attacks and the like over the Internet 2.

### 2. Second Exemplary Embodiment

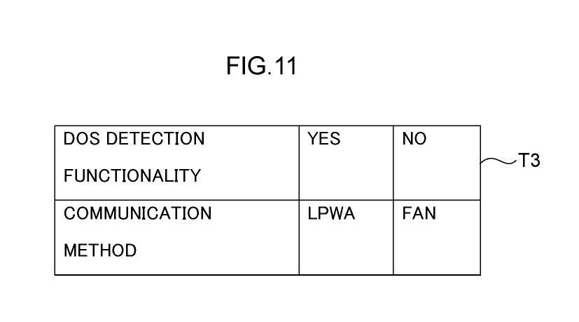

In the second exemplary embodiment, a communication method setting condition, which is a condition to determine the communication method for each of the sensor devices 6, is stored in a storage unit 22 (FIG. 3) of the gateway device 5 as a communication method setting table T3 as illustrated in FIG. 11, which corresponds to FIG. 4.

The communication method setting table T3 is prepared with headings for “DoS detection functionality” and “communication method”, is stored with “YES” or “NO” as values for the “DoS detection functionality”, and is stored with “LPWA” or “FAN” as values for the “communication method” associated therewith. Namely, the communication method setting table T3, “includes DoS detection functionality” is stipulates as a security condition in determining LPWA as the communication method.

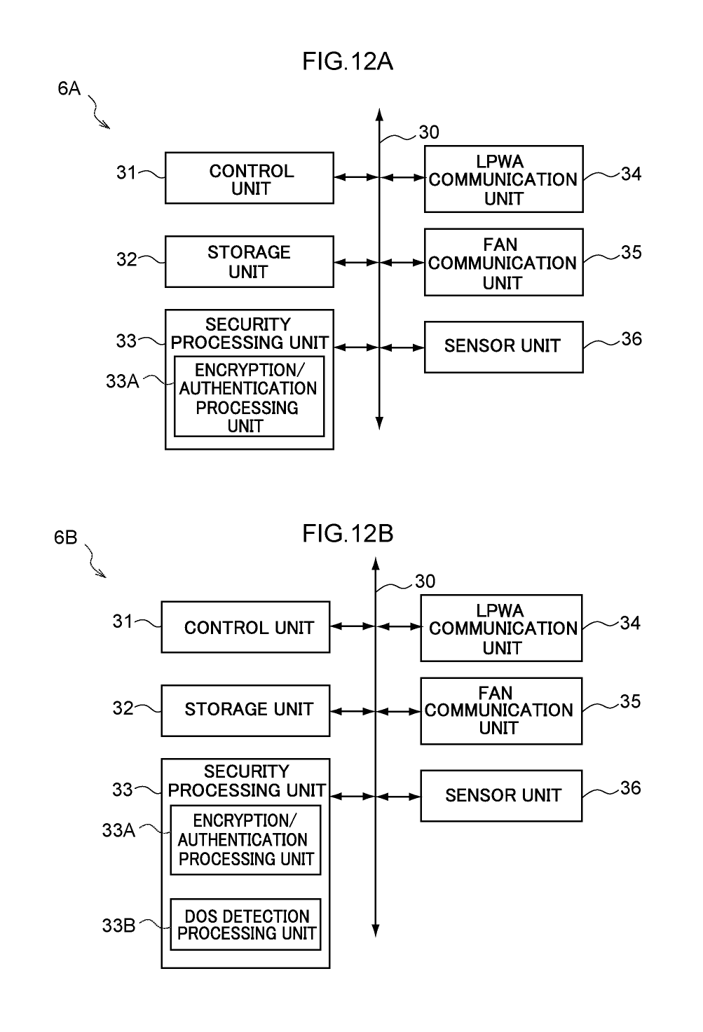

Moreover, in the second exemplary embodiment, as illustrated in FIG. 12A and FIG. 12B, which correspond to FIG. 5A and FIG. 5B, both the sensor devices 6A and 6B include the security processing unit 33; however, part of the functionality thereof differs therebetween.

More precisely, the security processing unit 33 in the sensor device 6A is provided with an encryption/authentication processing unit 33A. Although the security processing unit 33 has encryption functionality and authorization functionality, which are comparatively low-level security functionality, the security processing unit 33 does not have DoS detection functionality, which is comparatively high-level security functionality.

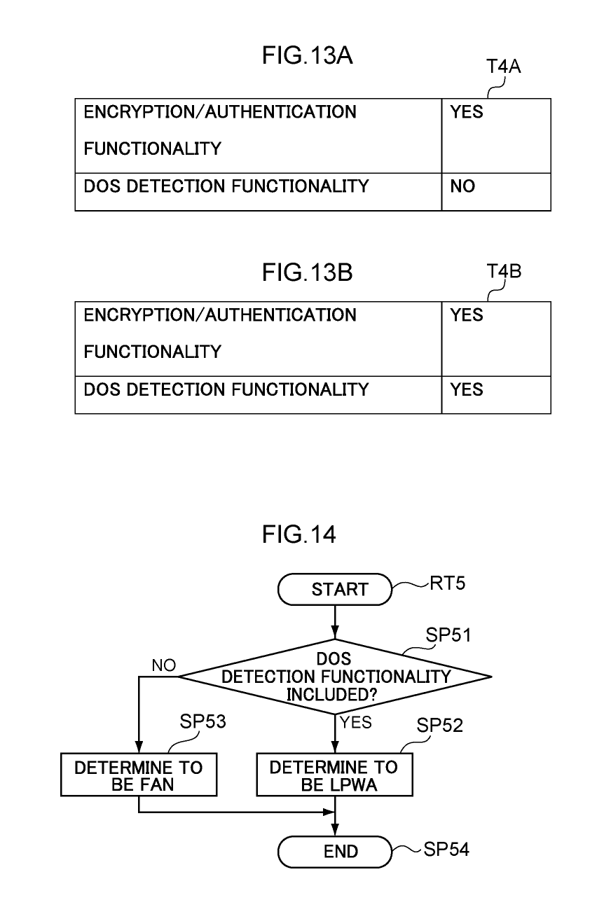

Accordingly, as illustrated in FIG. 13A, which corresponds to FIG. 6A, “YES” is stored associated with “encryption/authentication functionality” in the storage unit 32 of the sensor device 6A as security functionality information in a security information table T4A, and “NO” is stored therein associated with “DoS detection functionality”.

However, the security processing unit 33 of the sensor device 6B (FIG. 12B) is provided with a DoS detection processing unit 33B in addition to the encryption/authentication processing unit 33A, and so also includes DoS detection functionality. Accordingly, as illustrated in FIG. 13B, which corresponds to FIG. 6B, “YES” is stored associated both with “encryption/authentication functionality” and with “DoS detection functionality” in the storage unit 32 of the sensor device 6B as security functionality information in a security information table T4B.

Furthermore, in the second exemplary embodiment, when determining the communication method for the sensor devices 6 according to a sequence chart (FIG. 7), at step SP23, the gateway device 5 is configured to execute, as a subroutine, the communication method determination processing sequence RT5 illustrated in FIG. 14.

Namely, in the control unit 21 of the gateway device 5 (FIG. 3), when the communication method determination processing sequence RT5 starts, processing transitions to step SP51, and determination is made as to whether or not the sensor device 6 includes DoS detection functionality in its security functionality, or more precisely, whether or not the DoS detection functionality is “YES” in the security function information.

When an affirmative result is obtained, this means that the sensor device 6 is a sensor device 6B (FIG. 12B) including a DoS detection processing unit 33B in the security processing unit 33. Namely, suppose information were to be exchanged by LPWA between the sensor device 6B and the LPWA base station 4, leakage or alteration of information would be effectively prevented by encryption processing, authentication processing, or the like, and in addition appropriate countermeasures would be obtained to an external DoS attack over the Internet 2. When this is the case, in the control unit 21, processing then transitions to the next step SP52, and after determining the communication method this sensor device 6 should employ to be LPWA, processing transitions to the next step SP54.

However, when a negative result is obtained at step SP51, this means that the sensor device 6 is a sensor device 6A (FIG. 12A) lacking a DoS detection processing unit in the security processing unit 33. Namely, suppose information were to be exchanged by LPWA between the sensor device 6A and the LPWA base station 4, then there would be a concern that leakage or alteration of the information might occur, and moreover that it would not be possible to take sufficient countermeasures to an external DoS attack or the like over the Internet 2. However, if the sensor device 6A connects to the Internet 2 through the gateway device 5, then the security processing unit 23 (FIG. 3) of the gateway device 5 can be utilized, enabling sufficient countermeasures to an external DoS attack to be taken, and thereby enabling the security of information to be ensured. When this is the case, in the control unit 21, processing transitions to the next step SP53, and after determining the communication method this sensor device 6 (6A) should employ to be FAN, processing transitions to the next step SP54.

At step SP54, in the control unit 21, the communication method determination processing sequence RT5 subroutine ends, and after processing has transitioned to the next step SP24 in the original processing sequence RT2 (FIG. 7), subsequent processing similar to that of the first exemplary embodiment continues.

In the above configuration, in the second exemplary embodiment, the presence of DoS detection functionality as part of security functionality in the sensor devices 6 is used as a security condition by the communication method determination unit 21A (FIG. 3) provided to the control unit 21 of the gateway device 5, and the communication method determination unit 21A determines the communication method according to whether or not the security condition is satisfied.

Namely, in the sensor management system 1, the communication method is set to LPWA when the sensor device 6 is a sensor device 6B (FIG. 12B) including a DoS detection processing unit 33B, and sensing data is transmitted by LPWA communication between the sensor device 6B and the LPWA base station 4 without passing through the gateway device 5. In such cases, the sensor device 6B is able to take appropriate countermeasures against external DoS attacks over the Internet 2 due to the DoS detection processing unit 33B being included in the security processing unit 33.

However, in the sensor management system 1, when the sensor device 6 is a sensor device 6A (FIG. 12A) lacking DoS detection functionality in its security functionality, sensing data is transmitted by FAN communication between the sensor device 6A and the gateway device 5, with the sensing data being relayed through the gateway device 5 for transmission to the server device 3 over the Internet 2. Namely, although the sensor device 6A includes the LPWA communication unit 34, similarly to in the first exemplary embodiment, the sensor device 6A does not use the LPWA communication unit 34 and instead performs communication processing by FAN using the FAN communication unit 35. In such cases, in place of the sensor device 6A lacking DoS detection functionality, the gateway device 5 is able use the functionality of the security processing unit 23 to take appropriate countermeasures against external DoS attacks and the like over the Internet 2.

With regards to the sensor device 6A, the processing burden on the gateway device 5 can be reduced due to executing the encryption processing and authentication processing of the security functionality in the encryption/authentication processing unit 33A (FIG. 12A).

Regarding other points, similar operation and advantageous effects are exhibited in the sensor management system 1 of the second exemplary embodiment to those of the first exemplary embodiment.

According to the above configuration, the sensor management system 1 according to the second exemplary embodiment determines the communication method using the gateway device 5 according to the presence or absence of DoS detection functionality in the security functionality of the sensor device 6. Namely, the communication method is set to LPWA for sensor devices 6B including DoS detection functionality, enabling the processing burden on the gateway device 5 to be reduced, and also enabling countermeasures against DoS attacks to be taken by the DoS detection processing unit 33B in the security processing unit 33 of the sensor device 6B. However, the communication method is set to FAN for sensor devices 6A lacking DoS detection functionality, enabling countermeasures against DoS attacks to be taken by the security processing unit 23 of the gateway device 5 while maintaining a simple configuration. Thus in the sensor management system 1, sensing data can be safely transmitted from each of the sensor devices 6, and moreover, countermeasures against external attacks and the like over the Internet 2 can be taken.

### 3. Third Exemplary Embodiment

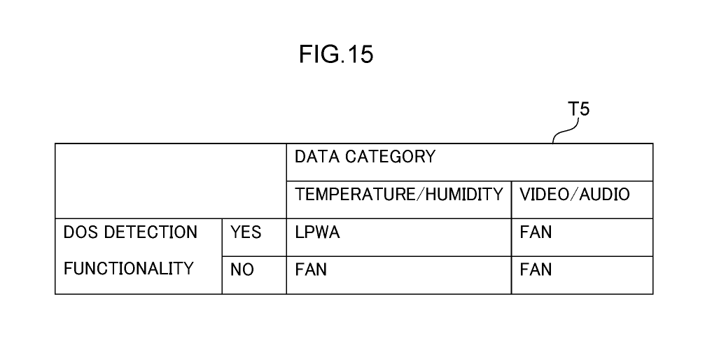

In a third exemplary embodiment, a communication method setting condition, which is a condition to determine the communication method of each of the sensor devices 6, is stored in a storage unit 22 (FIG. 3) of the gateway device 5 as a communication method setting table T5 as illustrated in FIG. 15, which corresponds to FIG. 4 and FIG. 11.

The communication method setting table T5 is prepared with two main categories “DoS detection functionality” and “data category”. The “DoS detection functionality” is prepared with sub-categories of “YES” or “NO”, and the “data category” is prepared with sub-categories of “temperature/humidity” and “video/audio”.

In addition, the communication method setting table T5 is stored with “LPWA” as the “communication method” only for the combination in which “DoS detection functionality” is “YES” and the “data category” is not “video/audio” (namely, for “temperature/humidity”). “FAN” is stored for all other combinations. Namely, in the communication method setting table T5, “DoS detection functionality included, and data category not video/audio” is stipulated as the security condition for determining the communication method to be LPWA.

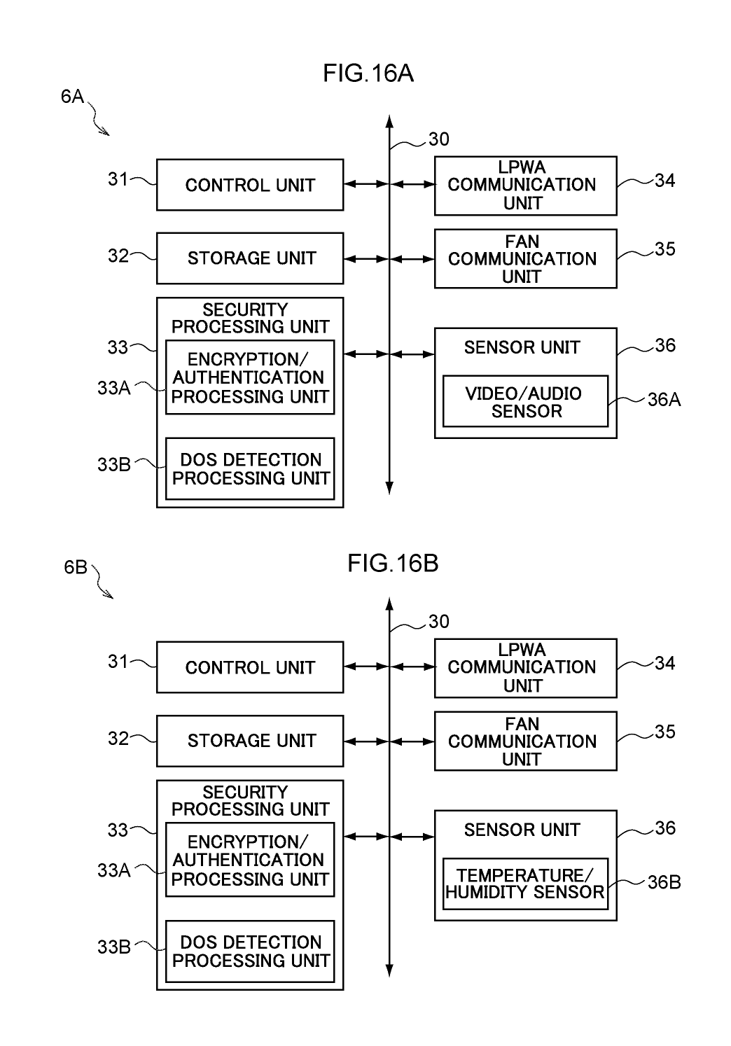

Moreover, in the third exemplary embodiment, as illustrated in FIGS. 16A and 16B, which correspond to FIG. 5A and FIG. 5B and to FIG. 12A and FIG. 12B, both sensor devices 6A and 6B include a security processing unit 33 and include a DoS detection processing unit 33B; however, the configuration of sensor units 36 differ therebetween.

More precisely, a video/audio sensor 36A, configured, for example, by a camera to image video and a microphone to pick up audio, is provided in the sensor unit 36 of the sensor device 6A. This sensor unit 36 thereby generates sensing data including a video signal and an audio signal.

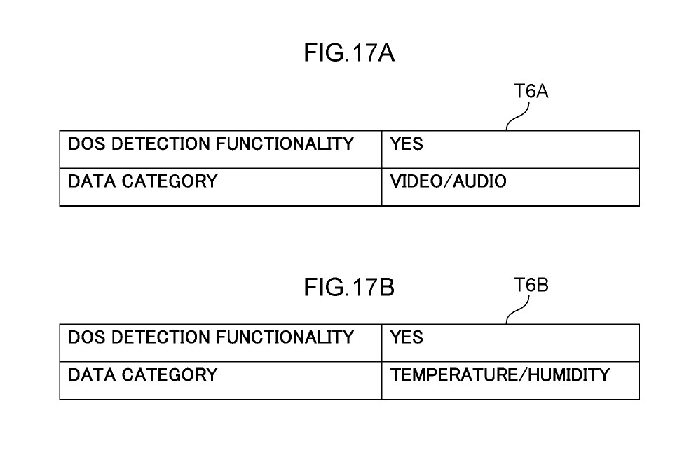

As illustrated in FIG. 17A, which corresponds to FIG. 6A and FIG. 13A, a storage unit 32 of the sensor device 6A is accordingly stored with “YES” associated with “DoS detection functionality” as part of security function information in a security information table T6A, and is moreover stored with “video/audio” associated with “data category” in the security information table T6A.

In the sensor unit 36 of the sensor device 6B, a temperature/humidity sensor 36B is configured by a temperature sensor to measure the temperature of the surroundings, a humidity sensor to measure the humidity of the surroundings, and the like. The sensor unit 36 accordingly generates sensing data representing measurement results of temperature and humidity.

As illustrated in FIG. 17B, which corresponds to FIG. 6B and FIG. 13B, the storage unit 32 of the sensor device 6B is accordingly stored with “YES” associated with “DoS detection functionality” as part of security function information in a security information table T6B, and is moreover stored with “temperature/humidity” associated with “data category” in the security information table T6B.

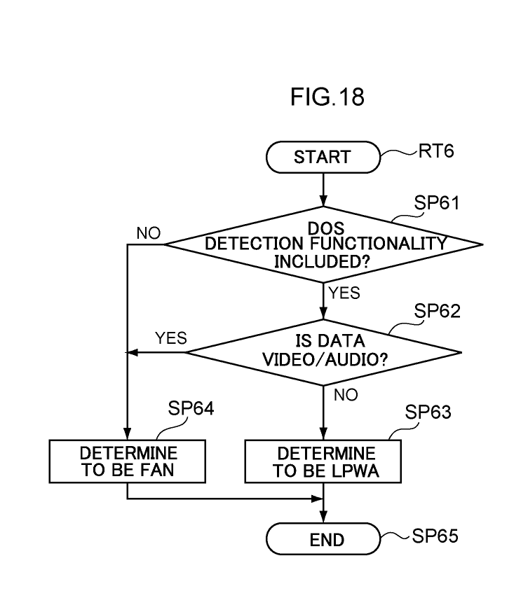

Furthermore, in the third exemplary embodiment, when determining the communication method of the sensor device 6 according to a sequence chart (FIG. 7), at step SP23, the gateway device 5 is configured to execute, as a subroutine, the communication method determination processing sequence RT6 illustrated in FIG. 18.

Namely, in the control unit 21 of the gateway device 5 (FIG. 3), when the communication method determination processing sequence RT6 starts, processing transitions to step SP61, and determination is made as to whether or not the sensor device 6 includes DoS detection functionality in its security functionality, or more precisely, whether or not the DoS detection functionality is “YES” in the security function information.

When an affirmative result is obtained, this means that suppose the sensor device 6 were to exchange information by LPWA with the LPWA base station 4, the sensor device 6 would be able to take appropriate countermeasures against external DoS attacks over the Internet 2. In other words, the sensor device 6 has at least sufficient functionality in terms of security functionality to exchange information by LPWA. In such cases, in the control unit 21, processing transitions to the next step SP62.

At the step SP62, the control unit 21 determines whether or not the data category for the sensor device 6 is video/audio. Obtaining a negative determination result here means that the sensor device 6 is a sensor device 6B including the temperature/humidity sensor 36B (FIG. 16B). Namely, the sensing data transmitted from the sensor device 6B is measurement results for temperature and humidity, and even supposing these were to be stolen by a third party, the possibility of this leading to a major data breach is extremely low. In such cases, in the control unit 21, processing then transitions to the next step SP63, and after determining the communication method that should be used by this sensor device 6 to be LPWA, processing transitions to the next step SP65.

However, when a negative determination result is obtained at step SP61, this means that the sensor device 6 lacks a DoS detection processing unit in the security processing unit 33, and thus possesses insufficient security functionality to exchange information by LPWA. In such cases, in the control unit 21, processing transitions to the next step SP64.

Moreover, when an affirmative determination result is obtained at step SP62, this means that the sensor device 6 is a sensor device 6A (FIG. 16A) including a video/audio sensor 36A. Namely, the sensing data transmitted from the sensor device 6A is video/audio data, and supposing these were to be stolen by a third party, the possibility of this leading to a major data breach is high. In such cases, in the control unit 21, processing transitions to the next step SP64.

At step SP64, in the control unit 21, after determining the communication method that should be used by this sensor device 6 to be FAN, processing transitions to the next step SP65. The sensor device 6 is accordingly able to communicate utilizing the security functionality included in the security processing unit 23 of the gateway device 5.

At step SP65, in the control unit 21, after the communication method determination processing sequence RT6 subroutine ends, and after processing transitions to the next step SP24 in the original processing sequence RT2 (FIG. 7), subsequent processing similar to that of the first exemplary embodiment continues.

In the above configuration, in the third exemplary embodiment, the presence of DoS detection functionality in the sensor device 6 and the category of the data to be generated not being video/audio is used as a security condition by the communication method determination unit 21A (FIG. 3) provided in the control unit 21 of the gateway device 5, and the communication method is determined according to whether or not the security condition is satisfied.

Namely, in the sensor management system 1, the communication method is set to LPWA when the sensor device 6 is a sensor device 6B (FIG. 16B) including a DoS detection processing unit 33B and in which the sensor unit 36 includes a temperature/humidity sensor 36B. The sensor device 6B accordingly transmits the sensing data by LPWA communication with the LPWA base station 4 without passing through the gateway device 5.

In such cases, the sensor device 6B includes the DoS detection processing unit 33B in the security processing unit 33, and is accordingly able to take appropriate countermeasures against external DoS attacks over the Internet 2. Moreover, the sensing data transmitted from the sensor device 6B is measurement results for temperature and humidity, and even supposing these were to be stolen by a third party, the possibility of this leading to a major data breach is extremely low. Thus, the necessary sufficient protection is obtained even with the security processing unit 33 of the sensor device 6B generally having lower performance than the security processing unit 23 of the gateway device 5.

However, in the sensor management system 1, sensing data is transmitted by FAN communication with the gateway device 5 when the sensor device 6 is a sensor device 6A (FIG. 16A) in which the sensor unit 36 includes a video/audio sensor 36A, even though the sensor device 6 includes DoS detection functionality in its security functionality. Namely, for the sensor device 6A, the data category is video/audio, and so were this to be stolen then there would be a high possibility of this leading to a major data breach, so even though the sensor device 6A includes the LPWA communication unit 34, the LPWA communication unit 34 is not used and instead communication processing is performed by FAN using the FAN communication unit 35. In such cases, the gateway device 5 utilizes the functionality of the security processing unit 23 of higher performance than the security processing unit 33 of the sensor device 6A, enabling the sensing data and the sensor device 6A to be strongly protected.

Regarding other points, the sensor management system 1 according to the third exemplary embodiment exhibits similar operation and advantageous effects to those of the first exemplary embodiment.

According to the above configuration, in the sensor management system 1 according to the third exemplary embodiment, the communication method by the gateway device 5 is determined according to the presence or absence of DoS detection functionality in the security functionality of the sensor device 6 and according to the data category. Namely, the processing burden on the gateway device 5 can be reduced while ensuring sufficient necessary security using the security processing unit 33 by setting LPWA as the communication method for sensor devices 6B including DoS detection functionality and having a data category of temperature/humidity. However, for sensor devices 6A in which the data category is video/audio, the sensing data and the like can be strongly protected by setting FAN as the communication method and using the security processing unit 23 of the gateway device 5. Thus in the sensor management system 1, the sensing data can be safely transmitted from each of the sensor devices 6, and moreover, countermeasures against external attacks and the like over the Internet 2 can be taken.

### 4. Fourth Exemplary Embodiment

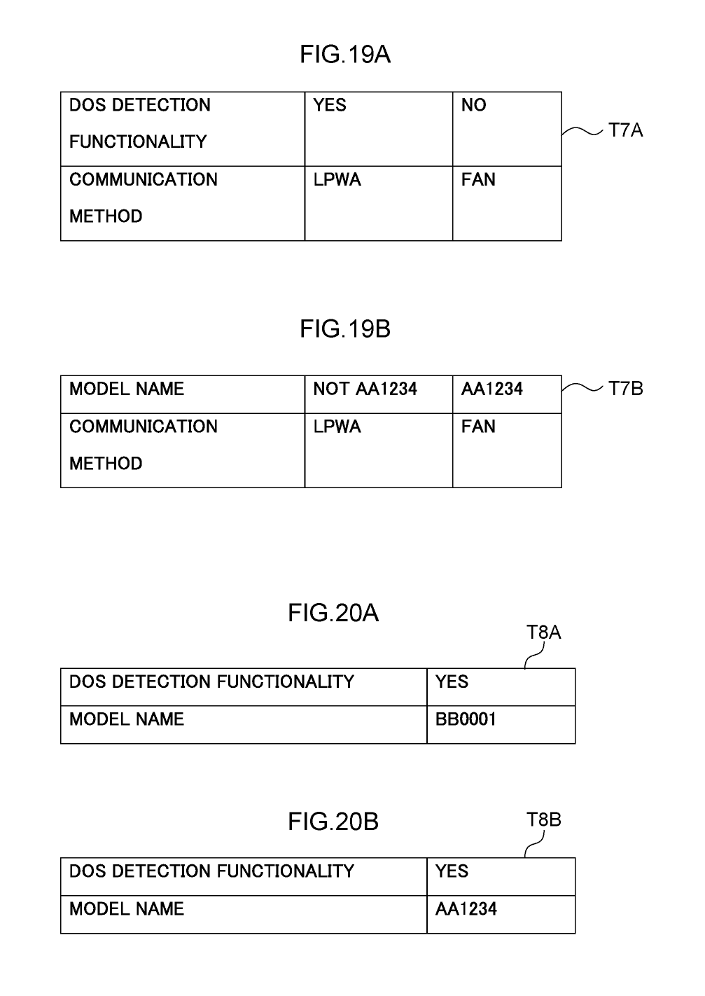

In a fourth exemplary embodiment, a communication method setting condition, which is a condition to determine the communication method of each of the sensor devices 6, is stored in a storage unit 22 (FIG. 3) of the gateway device 5 as communication method setting tables T7A and T7B illustrated in FIG. 19, which corresponds to FIG. 4, FIG. 11, and FIG. 15.

From out of the communication method setting tables, the communication method setting table T7A is similar to the communication method setting table T3 (FIG. 11) in the second exemplary embodiment. However, the communication method setting table T7B is prepared with headings for “model name” and “communication method”, and is stored with “NOT AA1234” or “AA1234” as values for the “model name”, and is stored with “LPWA” or “FAN” as values for the “communication method”. Namely, “DoS detection functionality included, and the model name not being “AA1234”” is stipulated in the communication method setting tables T7A and T7B as the security condition for determining the communication method to be LPWA.

In cases in which, for example, the model name “AA1234” is the name of a model in which problems have been found with the security processing unit 33 of the sensor device 6, the communication method setting table T7B is provided for the purpose of setting the communication method of the sensor device 6 to “FAN” so as to avoid using the security processing unit 33. In the storage unit 22 of the gateway device 5, at the initial stage there is only the communication method setting table T7A stored therein, and in practice this is similar to the second exemplary embodiment, however the communication method setting table T7B is added later thereto.

Moreover, in the fourth exemplary embodiment, similarly to in the third exemplary embodiment (FIG. 16A and FIG. 16B), both the sensor devices 6A and 6B include a security processing unit 33, and include a DoS detection processing unit 33B; however, the configurations of the model name stored as part of the device information in the storage unit 32 differ therebetween.

More precisely, the model name of the sensor device 6A is “BB0001”. Thus, as illustrated in FIG. 20A, which corresponds to FIG. 6A, FIG. 13A, and FIG. 17A, the storage unit 32 of the sensor device 6A is stored with “YES” associated with “DoS detection functionality” as part of the security function information in a security information table T8A, and is furthermore stored with “BB0001” associated with “model name” in the security information table T8A.

However, the model name of the sensor device 6B is “AA1234”. Thus, as illustrated in FIG. 20B, which correspond to FIG. 6B, FIG. 13B, and FIG. 17B, the storage unit 32 of the sensor device 6B is stored with “YES” associated with “DoS detection functionality” as part of the security function information in a security information table T8B, and is furthermore stored with “AA1234” associated with “model name” in the security information table T8B.

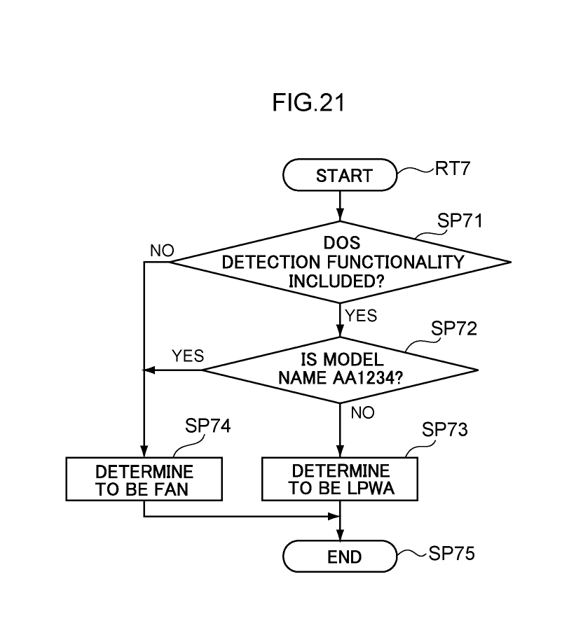

Furthermore, in the fourth exemplary embodiment, when determining the communication method of the sensor device 6 according to a sequence chart (FIG. 7), at step SP23, the gateway device 5 is configured to execute, as a subroutine, a communication method determination processing sequence RT7 as illustrated in FIG. 21.

Namely, in the control unit 21 (FIG. 3) of the gateway device 5, when the communication method determination processing sequence RT7 starts, processing transitions processing to step SP71, and determination is made as to whether or not the sensor device 6 includes DoS detection functionality in its security functionality, or more precisely whether or not the DoS detection functionality is “YES” in the security function information.

When an affirmative result is obtained, this means that suppose the sensor device 6 were to exchange information by LPWA with the LPWA base station 4, the sensor device 6 would normally be able to take appropriate countermeasures against external DoS attacks over the Internet 2. In such cases, in the control unit 21, processing transitions to the next step SP72.

At step SP72, the control unit 21 determines whether or not the model name of the sensor device 6 is “AA1234”. Obtaining a negative determination result here means that there is no problem with the security processing unit 33 of the sensor device 6, and so is available for use. In such cases, in the control unit 21, processing then transitions to the next step SP73, and after determining the communication method that should be used by the sensor device 6 to be LPWA, processing transitions to the next step SP75.

However, when a negative determination result is obtained at step SP71, this means that the security processing unit 33 of the sensor device 6 lacks a DoS detection processing unit, meaning that there is insufficient security functionality for exchange information by LPWA. In such cases, in the control unit 21, processing transitions to the next step SP74.

Moreover, when a negative determination result is obtained at step SP72, this means that the model name of the sensor device 6 is “AA1234”, and there is accordingly a problem with the security processing unit 33 therein, so LPWA should not be employed as the communication method. In such cases, in the control unit 21, processing transitions to the next step SP74.

At step SP74, in the control unit 21, after determining the communication method that should be used by the sensor device 6 to be FAN, processing transitions to the next step SP75. The sensor device 6 is accordingly able to communicate utilizing the security functionality included in the security processing unit 23 of the gateway device 5.

At step SP75, in the control unit 21, after the communication method determination processing sequence RT7 subroutine ends, and after processing transitions to the next step SP24 in the original processing sequence RT2 (FIG. 7), subsequent processing similar to that of the first exemplary embodiment continues.

In the above configuration, in the fourth exemplary embodiment, the presence of DoS detection functionality in the sensor device 6 and the model name of the sensor device 6 not being “AA1234” is used as a security condition by the communication method determination unit 21A (FIG. 3) provided in the control unit 21 of the gateway device 5, and the communication method is determined according to whether or not the security condition is satisfied.

Namely, in the sensor management system 1, when the sensor device 6 includes the DoS detection processing unit 33B and the model name other than “AA1234”, such as “BB0001”, the communication method is set to LPWA and the sensing data is transmitted by LPWA communication between the sensor device 6 and the LPWA base station 4, without passing through the gateway device 5. In such cases, the sensor device 6 is able to take appropriate countermeasures against external DoS attacks over the Internet 2 due to the DoS detection processing unit 33B being included in the security processing unit 33.

However, in the sensor management system 1, in cases in which the model name is “AA1234”, the sensing data is transmitted between the sensor device 6 and the gateway device 5 by FAN communication even though the sensor device 6 includes DoS detection functionality in its security functionality. Namely, although such a sensor device 6 includes the security processing unit 33, due to a problem having been found therewith, it would be inappropriate use the security processing unit 33 to communicate by LPWA, and so communication processing is performed by FAN using the FAN communication unit 35 despite the LPWA communication unit 34 being included. In such cases, regular security processing can be performed by the security processing unit 23 of the gateway device 5, enabling the sensing data and the sensor device 6 to be appropriately protected.

In the fourth exemplary embodiment, for example, the communication method setting table T7B is erased from the storage unit 22 of the gateway device 5 in cases in which the model name of the sensor device 6B is “AA1234”, and the problem with the security processing unit 33 has been eliminated by updating firmware, replacing a component, or the like. Accordingly, when the control unit 21 of the gateway device 5 sets the communication method of the sensor device 6 according to a sequence chart (FIG. 7), the communication method determination processing sequence RT5 (FIG. 14) is executed as a subroutine at step SP23, similarly to in the second exemplary embodiment. The communication method to be employed by the sensor device 6B having the security processing unit 33 is thereby set to LPWA.

Regarding other points, similar operation and advantageous effects are exhibited in the sensor management system 1 according to the fourth exemplary embodiment to those of the first exemplary embodiment.

According to the above configuration, the sensor management system 1 according to the fourth exemplary embodiment determines the communication method using the gateway device 5 according to the presence or absence of DoS detection functionality in the security functionality of the sensor device 6 and according to the model name thereof. Namely, the processing burden on the gateway device 5 can be reduced while ensuring sufficient necessary security using the security processing unit 33 by setting LPWA as the communication method for sensor devices 6B including DoS detection functionality and having a model name other than the name “AA1234”. However, for sensor devices 6A in which the model name is “AA1234”, the communication method is set to FAN, and sensing data and the like is protected by the security processing unit 23 of the gateway device 5. Thus, in the sensor management system 1, the sensing data can be safely transmitted from each of the sensor devices 6, and moreover, countermeasures against external attacks and the like over the Internet 2 can be taken.

### 5. Other Exemplary Embodiments

Note that examples were given of cases in which the security condition was “security functionality included” (FIG. 4) in the first exemplary embodiment described above, and in which the security condition was “DoS detection functionality included” in the second exemplary embodiment (FIG. 11). However, the present disclosure is not limited thereto, and, for example, “encryption/authentication functionality included”, “advanced encryption standard (AES) with a key length of 256 bits or longer”, “includes security functionality not less than that of the gateway device 5”, or the like may be employed as the security condition, or various requirements related to security may be employed as the security condition. Furthermore, for example, after assigning a level using numerical values to requirements related to security and defining security levels, “a security level of a predetermined reference level or higher” may be employed as the security condition. Moreover, the security condition is not limited to a security condition stored in advance in the storage unit 22 of the gateway device 5, and, for example, may be a security condition notified by the server device 3.

Moreover, in the third exemplary embodiment, a case was given in which the security condition was “the sensor device 6 including DoS detection functionality and the category of data to be generated not being video/audio”. Furthermore, in the fourth exemplary embodiment, a case was given in which the security condition was “the sensor device 6 including DoS detection functionality and the model name of the sensor device 6 not being “AA1234””. However, the present disclosure is not limited thereto, and, for example, “the sensor device 6 includes DoS detection functionality and was manufactured by a predetermined manufacturer”, or the like, may be employed as the security condition, or a combination of security functionality and various other requirements may be employed as the security condition.

Moreover, in the first exemplary embodiment, a case was given in which the security information table T2 (FIG. 6) was stored as part of device information in the storage unit 32 of the sensor device 6. However, the present disclosure is not limited thereto, and, for example, the security information table T2 may be omitted from the storage unit 32. In such cases, for example, the sensor device 6 may detect the functionality related to security possessed by itself by executing a predetermined self-functionality scan program in the control unit 31, and notify the gateway device 5 of the result obtained therefrom. Alternatively, a request to execute security functionality may be made to the sensor device 6 by the gateway device 5, and the presence or absence of security functionality may be determined in the gateway device 5 based on the execution results obtained. In such cases, for example, in cases in which it is detected that a certain functionality is installed but that the functionality is not operating normally, this may be taken as the functionality not being included, and determination may be made as to whether or not the security condition is satisfied based only on functionality operating normally. Similar applies to the second to the fourth exemplary embodiments. From out of these exemplary embodiments, in the third exemplary embodiment, for example, the data category may be determined by analyzing the content of data the gateway device 5 has transmitted to the sensor device 6.

Furthermore, in the third exemplary embodiment described above, a case was given in which the security condition was only the one condition of “the sensor device 6 including DoS detection functionality and the category of data to be generated not being video/audio”. However, the present disclosure is not limited thereto, and, for example, a security condition may be provided for each category of data.

Furthermore, in the first exemplary embodiment described above, a case was given in which in the sequence chart (FIG. 7) to determine the communication method, the communication method of the sensor device 6 is determined and notified by the gateway device 5 (step SP23 and step SP24), and the sensor device 6 accordingly sets the communication method itself (step SP14). However, the present disclosure is not limited thereto, and, for example, the communication method of the sensor device 6 determined by the gateway device 5 may be displayed on the display unit 27 of the gateway device 5, or the communication method of the sensor device 6 may be notified to the user by sending an email to a pre-designated email address. The user is thereby not only able to confirm the determined communication method, but is also able to set the communication method of the sensor device 6 by manual operation or the like. Similar applies to the second to the fourth exemplary embodiments.

Furthermore, in the first exemplary embodiment described above, a case was given in which in the sequence chart (FIG. 7) for determining the communication method, after the communication method of the sensor device 6 has been determined in the gateway device 5, the information of the sensor device 6 is transmitted to the server device 3 (step SP25 and step SP32). However, the present disclosure is not limited thereto, and, for example, the processing of step SP25 and step SP32 may be omitted. In such cases, for example, a request to transmit information may be made by the server device 3 to the sensor device 6, and the information obtained thereby may be stored by the server device 3, or configuration may be made such that information related to the sensor device 6 is not stored on the server device 3. Similar applies to the second to the fourth exemplary embodiments.

Furthermore, in the first exemplary embodiment described above, a case was given in which, on the communication route display screen D1 (FIG. 10) displayed on the display unit 17 of the server device 3, each of the communication routes in the sensor management system 1 is displayed as an image combining the graphic symbols, such as F3 representing the server device 3, bent lines, and the like. However, the present disclosure is not limited thereto, and, for example, presentation may be made to the user using various presentation methods such as displaying a text string such as “the server device 3 is wirelessly connected to the Internet 2”. Similar applies to the second to the fourth exemplary embodiments.

Furthermore, in the first exemplary embodiment described above, a case was given in which temperature and humidity data is collected by the sensor unit 36. However, the present disclosure is not limited thereto, and various data may be collected by the sensor unit 36 such as, for example, video/audio, or illumination and sound levels or the like. Similar applies to the second to the fourth exemplary embodiments.

Furthermore, in the first exemplary embodiment described above, a case was given in which the processing sequence RT1 (FIG. 7) is started when power to the sensor device 6 is switched ON. However, the present disclosure is not limited thereto, and, for example, the processing sequence RT1 may be started at various timings, such as when a reset button has been operated, or when notified by the server device 3, the gateway device 5, or the like to re-determine the communication method. Alternatively, when the security condition in the gateway device 5 has been updated, the communication method may be re-determined according to the security condition post-update. Alternatively, the processing sequence RT1 may be repeatedly started at predetermined intervals (such as every day, every week, or every month) while the power to the sensor device 6 is switched ON. Thereby, for example, if part of the security functionality no longer operates normally due to a malfunction, then the communication method can be switched from LPWA to FAN, enabling collection of sensing data to continue while using the security functionality of the gateway device 5. Similar applies to the second to the fourth exemplary embodiments.

Furthermore, in the first exemplary embodiment described above, a case was given in which the communication method determination program was pre-stored in the flash memory, the storage unit 22, or the like in the control unit 21 of the gateway device 5. However, the present disclosure is not limited thereto, and, for example, the communication method determination program may be downloaded from the server device 3 or another server connected to the Internet 2, and stored, and then this communication method determination program executed. Similar applies to the second to the fourth exemplary embodiments.

Furthermore, in the exemplary embodiments described above, a case was given in which, when the sensor devices 6 are compatible with two communication methods, LPWA and FAN, the communication method of each of the sensor devices 6 is determined by the gateway device 5 to be one of these. However, the present disclosure is not limited thereto, and, in cases in which the sensor devices 6 are compatible with two or more of various types of communication method, the communication method of each of the sensor devices 6 may be determined by the gateway device 5 to be any thereof.

Furthermore, the present disclosure is not limited to each of the exemplary embodiments and the other exemplary embodiments described above. Namely, the present disclosure has a scope of application encompassing freely selected combinations of part or all of the exemplary embodiments and the other exemplary embodiments described above, and exemplary embodiments from which part has been extracted.

Furthermore, in the exemplary embodiments described above, cases were given in which the sensor management system 1 serving as a sensor management system includes the sensor devices 6 (6A and 6B) serving as sensor devices, the gateway device 5 serving as a sensor management device, the LPWA base station 4 serving as a communication device, the server device 3 serving as a server device, and in which the sensor management device is configured by the communication method determination unit 21A serving as a communication method determination unit. However, the present disclosure is not limited thereto, and, the sensor management system may be configured from sensor devices, a sensor management device, a communication device, and a server device of various other configurations, and the sensor management device may be configured by a communication method determination unit of various other configurations.

The present disclosure may, for example, be utilized in cases in which a communication method is determined for a sensor device compatible with plural communication methods.

A sensor management system of the present disclosure includes: a sensor device that collects data and transmits the collected data by a first communication method or a second communication method; a sensor management device including predetermined security functionality, wherein the sensor management device receives the data in a case in which the data has been transmitted from the sensor device by the first communication method and transmits the received data to a predetermined network; a communication device that relays the data to the network in a case in which the data has been transmitted from the sensor device by the second communication method; and a server device that receives the data from the sensor management device or from the communication device via the network. The sensor management device includes a communication method determination unit that determines, based on a security configuration included in the sensor device, a communication method for use by the sensor device, in a case of transmitting the data, to be either the first communication method or the second communication method.

Moreover, a sensor management method for a sensor management system of the present disclosure includes: a sensor device that collects data and transmits the collected data by a first communication method or a second communication method, a sensor management device including predetermined security functionality, wherein the sensor management device receives the data in a case in which the data has been transmitted from the sensor device by the first communication method and transmits the received data to a predetermined network, a communication device that relays the data to the network in a case in which the data has been transmitted from the sensor device by the second communication method, and a server device that receives the data from the sensor management device or from the communication device via the network, the sensor management method comprising: using a predetermined communication unit to identify a security configuration included in the sensor device; and using a predetermined communication method determination unit to determine, based on the identified security configuration, a communication method for use by the sensor device, in a case of transmitting the data, to be either the first communication method or the second communication method.

Furthermore, a recording medium storing a sensor management program of the present disclosure is executable by a processor of a sensor management device in a sensor management system. The sensor management system includes: a sensor device that collects data and transmits the collected data by a first communication method or a second communication method, a sensor management device including predetermined security functionality, wherein the sensor management device receives the data in a case in which the data has been transmitted from the sensor device by the first communication method and transmits the received data to a predetermined network, a communication device that relays the data to the network in a case in which the data has been transmitted from the sensor device by the second communication method, and a server device that receives the data from the sensor management device or from the communication device via the network. The sensor management program causes the processor of the sensor management device to perform processing. The processing includes: identifying a security configuration included in the sensor device; and based on the identified security configuration, determining a communication method for use by the sensor device, in a case of transmitting the data, to be either the first communication method or the second communication method.

Furthermore, a sensor management device of the present disclosure includes: a sensor-side communication unit that receives, from a sensor device that collects data and transmits the collected data using a first communication method or a second communication method, the data in a case in which the data has been transmitted by the first communication method; a network-side communication unit that transmits the data received from the sensor device to a predetermined network; a security processing unit that performs predetermined security processing on the data received from the sensor device; and a communication method determination unit that, based on a security configuration included in the sensor device, determines a communication method for use by the sensor device when transmitting the data to be either the first communication method or the second communication method.

In the present disclosure, in cases in which a sensor device is capable of transmitting data by a first communication method or a second communication method, determination can be made according to the security functionality included in the sensor device as to whether to use the first communication method utilizing the security functionality of a communication management device, or a second communication method utilizing the security functionality of the sensor device.

The present disclosure enables the realization of a sensor management system capable of determining a communication method appropriate to a sensor device, while ensuring security, and the realization of a sensor management method, a sensor management program, and a sensor management device of the same.

What is claimed is:

1. A sensor management system, comprising:
a sensor device that collects data and transmits the collected data by a first communication method or a second communication method;
a sensor management device including predetermined security functionality, wherein the sensor management device receives the data in a case in which the data has been transmitted from the sensor device by the first communication method and transmits the received data to a predetermined network;
a communication device that relays the data to the network in a case in which the data has been transmitted from the sensor device by the second communication method; and
a server device that receives the data from the sensor management device or from the communication device via the network,
wherein the sensor management device includes a communication method determination unit that determines, based on a security configuration included in the sensor device, a communication method for use by the sensor device, in a case of transmitting the data, to be either the first communication method or the second communication method.

2. The sensor management system of claim 1, wherein:
the communication method determination unit selects the second communication method in a case in which the sensor device satisfies a predetermined security condition related to the security configuration; and
the communication method determination unit selects the first communication method in a case in which the sensor device does not satisfy the security condition.

3. The sensor management system of claim 2, wherein the security condition is that the sensor device includes security functionality.

4. The sensor management system of claim 3, wherein the security condition is that a security level having a numerical value assigned to the security functionality of the sensor device is a predetermined reference level or higher.

5. The sensor management system of claim 2, wherein the security condition is that the sensor device includes security functionality that is the same as or better than the predetermined security functionality of the sensor management device.

6. The sensor management system of claim 2, wherein notification of the security condition is provided from the server device.

7. The sensor management system of claim 2, wherein, in a case in which the security condition has been updated, the communication method determination unit re-determines, according to the updated security condition, a communication method of the sensor device for which the communication method was already determined.

8. The sensor management system of claim 1, wherein the communication method determination unit determines the communication method of the sensor device according to a type of the data collected by the sensor device as well as according to security functionality included in the sensor device.

9. The sensor management system of claim 8, wherein the communication method determination unit determines the communication method of the sensor device to be the first communication method in a case in which the data collected by the sensor device includes at least one of image or audio data.

10. The sensor management system of claim 1, further comprising a presentation unit that presents the communication method determined by the communication method determination unit to a user.

11. The sensor management system of claim 10, wherein the presentation unit presents the user with the communication method determined by the communication method determination unit using an image in which at least the sensor device and the sensor management device are each represented by a graphic symbol.

12. A sensor management method for a sensor management system including a sensor device that collects data and transmits the collected data by a first communication method or a second communication method, a sensor management device including predetermined security functionality, wherein the sensor management device receives the data in a case in which the data has been transmitted from the sensor device by the first communication method and transmits the received data to a predetermined network, a communication device that relays the data to the network in a case in which the data has been transmitted from the sensor device by the second communication method, and a server device that receives the data from the sensor management device or from the communication device via the network, the sensor management method comprising:
using a predetermined communication unit to identify a security configuration included in the sensor device; and
using a predetermined communication method determination unit to determine, based on the identified security configuration, a communication method for use by the sensor device, in a case of transmitting the data, to be either the first communication method or the second communication method.

13. A recording medium storing a sensor management program that is executable by a processor of a sensor management device in a sensor management system, the sensor management system including a sensor device that collects data and transmits the collected data by a first communication method or a second communication method, a sensor management device including predetermined security functionality, wherein the sensor management device receives the data in a case in which the data has been transmitted from the sensor device by the first communication method and transmits the received data to a predetermined network, a communication device that relays the data to the network in a case in which the data has been transmitted from the sensor device by the second communication method, and a server device that receives the data from the sensor management device or from the communication device via the network, the sensor management program causing the processor of the sensor management device to perform processing, the processing comprising:
identifying a security configuration included in the sensor device; and
based on the identified security configuration, determining a communication method for use by the sensor device, in a case of transmitting the data, to be either the first communication method or the second communication method.

14. A sensor management device, comprising:
a sensor-side communication unit that receives, from a sensor device that collects data and transmits the collected data using a first communication method or a second communication method, the data in a case in which the data has been transmitted by the first communication method;
a network-side communication unit that transmits the data received from the sensor device to a predetermined network;
a security processing unit that performs predetermined security processing on the data received from the sensor device; and
a communication method determination unit that, based on a security configuration included in the sensor device, determines a communication method for use by the sensor device when transmitting the data to be either the first communication method or the second communication method.
